(19) United States
(12) Patent Application Publication
(10) Pub. No.: US 2021/0295349 A1
(43) Pub. Date: Sep. 23, 2021

(54) SYSTEM FOR VENDOR CORRECTION OF ERRORS

(71) Applicant: Walmart Apollo, LLC, Bentonville, AR (US)

(72) Inventors: John Steven Meredith, Bentonville, AR (US); Zachary Watts, Bentonville, AR (US); Jason Scott Hayes, Bentonville, AR (US); Timothy James Burleson, Bentonville, AR (US); Anthony James Hight, Lafayette, LA (US)

(21) Appl. No.: 17/206,611

(22) Filed: Mar. 19, 2021

Related U.S. Application Data
(60) Provisional application No. 62/992,630, filed on Mar. 20, 2020.

(51) Int. Cl. G06Q 30/00; G06Q 10/08

(52) U.S. Cl. CPC G06Q 30/018; G06Q 10/083

(57) ABSTRACT

Examples provide a system and method for handling non-damage related errors in received freight. A front-end error handling application applies a set of user-configurable rules to obtain information associated with a detected error in a received item. The error handling application creates a ticket, including a predetermined number of images of the received item, for uploading to a vendor correction of errors (VCOE) backend for resolving the error tickets. The VCOE component determines when to deny or close error tickets and sends notifications requesting appropriate remedies to resolve error tickets to one or more providers associated with the non-compliant received item. The provider can include a vendor, carrier, or distribution center. Aggregated data from a plurality of error tickets is provided via a dashboard for user review.

### BACKGROUND

Pallets of goods from vendors are frequently shipped to distribution centers via carriers. If the goods arrive with non-damage related errors in shipments, the current remedy typically involves performing a tedious process of manually identifying the errors, identifying the vendor and/or carrier responsible, and providing feedback to the vendor or carrier in pursuit of a remedy one issue at a time. Moreover, if the error is due to non-compliance in a shipment received at a distribution center from another distribution center, the user generally performs a manual identification of errors and provides feedback to the distribution center via a separate system and network. This can be a complicated, inefficient, and time-consuming process subject to potential human error.

### SUMMARY

Some examples provide a system, method, and computer executable-instructions for handling non-damage related errors in received freight. In some examples an error handling application creates an error ticket associated with a detected non-damage related error in at least one received item at a point of origin based on a first set of user-configurable rules. A user interface component prompts a user to provide additional information if a set of user-configurable rules indicates at least one item of additional information is desirable based on a type of the detected non-damage related error. A rules engine identifies a pre-determined number of images of the received items to be uploaded with the error ticket based on at least one of a type of the received item, the type of the detected non-damage related error and a provider associated with the received item. A set of one or more image capture devices captures a set of images of the received item including the pre-determined number of images. A communications interface component uploads the error ticket to an error resolution component associated with a cloud server via a network. The error ticket including at least one of the additional information and the set of images of the received item.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is an exemplary block diagram illustrating a system for handling errors in received freight.

FIG. 2 is an exemplary block diagram illustrating a system including a vendor correction of errors (VCOE) component on a cloud server for handling errors in received freight.

FIG. 3 is an exemplary block diagram illustrating a system including a cloud database for handling errors in received freight.

FIG. 4 is an exemplary block diagram illustrating a system including a VCOE component generating alert notifications to item providers.

FIG. 5 is an exemplary block diagram illustrating a VCOE component for processing and handling error tickets.

FIG. 6 is an exemplary block diagram illustrating a notification component for generating alert notifications.

FIG. 6 is an exemplary block diagram illustrating a set of rules for handling error tickets.

FIG. 7 is an exemplary block diagram illustrating a user device hosting an error handling component for creating error tickets.

FIG. 8 is an exemplary block diagram illustrating a user device including an error handling component for generating error tickets.

FIG. 9 is an exemplary block diagram illustrating a screenshot of a user device including a display having fields associated with creating an error ticket.

FIG. 10 is an exemplary block diagram illustrating a screen shot of a user device including a display associated with identifying an item affected by a non-damage related error.

FIG. 11 is an exemplary block diagram illustrating a screenshot of a user device including a display associated identifying items affected by an error.

FIG. 12 is an exemplary flow chart illustrating operation of the computing device to generate and upload an error ticket to a VCOE component.

FIG. 13 is an exemplary flow chart illustrating operation of the computing device to guide a user via a user interface in generating an error ticket via the Error handling component.

FIG. 14 is an exemplary flow chart illustrating operation of the computing device to request images based on a set of rules.

FIG. 15 is an exemplary flow chart illustrating operation of the computing device to retrieve additional information for an error ticket based on user-provided data.

FIG. 16 is an exemplary flow chart illustrating operation of the computing device to handle an error ticket in accordance with one or more user-configured rules.

FIG. 17 is an exemplary flow chart illustrating operation of the computing device to determine whether to close an error ticket.

FIG. 18 is an exemplary flow chart illustrating operation of the computing device to utilizes a set of rules to generate an error ticket for non-damage related errors in received freight.

Corresponding reference characters indicate corresponding parts throughout the drawings.

### DETAILED DESCRIPTION

A more detailed understanding can be obtained from the following description, presented by way of example, in conjunction with the accompanying drawings. The entities, connections, arrangements, and the like that are depicted in, and in connection with the various figures, are presented by way of example and not by way of limitation. As such, any and all statements or other indications as to what a particular figure depicts, what a particular element or entity in a particular figure is or has, and any and all similar statements, that can in isolation and out of context be read as absolute and therefore limiting, can only properly be read as being constructively preceded by a clause such as “In at least some examples, . . . ” For brevity and clarity of presentation, this implied leading clause is not repeated ad nauseum.

Referring to the figures, the examples of the disclosure enable a system for handling error tickets. Some examples the system includes a vendor correction of errors (VCOE) component that autonomously handles non-damage related errors associated with freight received at a distribution center based on a set of user-configurable rules. This enables more accurate and consistent handling of non-damage related errors in received freight while reducing mishandling of errors due to human error or delay.

Aspects of the disclosure further enable user-configurable set of rules for determining how to handle error tickets and when to close the tickets. This improves ticket handling efficiency while minimizing time and costs associated with error ticket processing.

Other examples provide a VCOE component that handles error tickets associated with vendor error, carrier error and distribution center (DC) to DC errors. The VCOE component is enabled to communicate with DC applications as well as transmit notifications to vendor and carrier systems. This consolidates two error handling systems into one more efficient system.

In other examples, the VCOE system processes, analyzes and aggregates error ticket data for display via a user dashboard. The dashboard provides a user interface presenting charts, summaries, reports, analysis results and other aggregated data for user review. This enables users to quickly and easily obtain information organized into categories and groups based on types of errors, frequency of errors, vendor and carrier rates of errors, errors per DC, and other summarized information. The dashboard reduces user time analyzing error data while further improving user efficiency via the dashboard interface.

In some examples, the system provides a user device running an error handling component which operates in an unconventional manner by prompting a user as to information required for generation of error tickets, as well as identifying additional information, such as item images, which may be desirable for resolving the error tickets during processing by the VCOE component. The Error handling component uploads the gathered error ticket data to the VCOE component for resolution. In this manner, the user device enables more accurate and efficient error ticket generation for issue resolution.

In still other examples, the system provides a set of sensor devices, such as cameras and scanner devices, for generating information associated with error ticket generation. The sensor devices operate in an unconventional manner by automatically scanning barcodes, labels, and other identifying marking to identify the type of items. The sensor devices can also automatically capture the appropriate number of images of an item for inclusion with the error ticket data. The sensor data is uploaded with the error ticket data to the VCOE component for error ticket handling. This further improves error ticket generation time, efficiency and accuracy while preventing uploading of error tickets lacking appropriate item identification data and item images where desired for error handling.

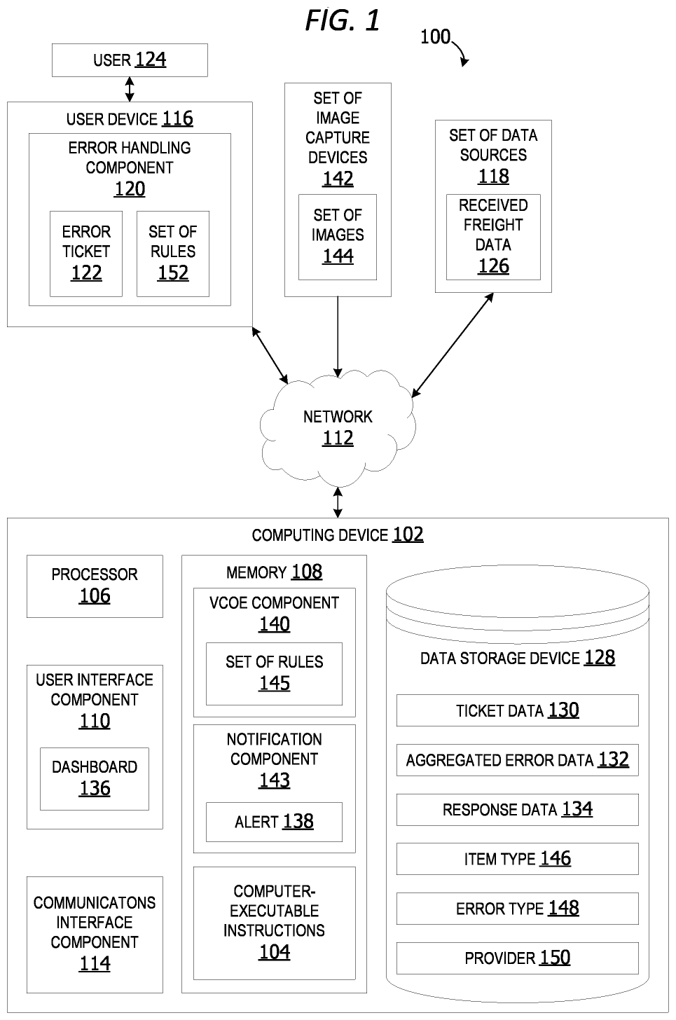

Referring again to FIG. 1, an exemplary block diagram illustrates a system 100 for handling errors in received freight. Non-damage related errors in received freight include errors or mistakes in freight shipping and handling that does not meet established standards.

Non-damage related errors in received freight can include, for example, poor load quality, poor pallet quality, product quality, incorrect pallet build securement, packing infractions, etc. Packing infractions refer to non-compliance with packaging and labeling instructions for pallets coming into a DC, warehouse, or other receiving station. Pallet build securement refers to how pallets are put together, such as the order in which items or cases are placed on the pallet, how the pallet is wrapped, size of the items or cases on the pallet, weight of the items or cases on the pallet, etc. Load quality refers to the manner in which pallets are loaded into a trailer, such as, but not limited to, placement of pallets inside the trailer, orientation of pallets in the trailer, loading sequence, stacking of items in the trailer, etc. Product quality refers to the condition of items or cases, such as, but not limited to, item or case packaging, etc. Pallet quality refers to quality of materials used to build the pallets, type of boards, condition of boards, size of boards, etc.

Some examples of non-damage related errors include, without limitation, missing labels, incorrect labeling, illegible labels, torn labels, unreadable barcode, missing barcode, incorrect barcode, inaccurate barcode, smudged writing on labeling, torn packaging, etc. Some other non-limiting examples of non-damage related errors in received freight include, without limitation, improper stretch wrap used, incorrect tension on the stretch wrap, insufficient stretch wrap used on pallet, items or cases on a pallet hanging over the edge of the pallet, broken or cracked boards in the pallet, incorrect size or type of boards used in wooden pallet, pallets not built layer-by-layer, heavy items placed on top of lighter or fragile items in a higher layer on the pallet, lightweight items placed in bottom or lower layers of the pallet, etc.

Still other examples of non-damage related errors can include shifted load, shifted pallets, pallets that are not secured properly, pallets that are fallen over within the truck, items that are misplaced or fallen over inside the pallet due to poor or incorrect pallet build, purchase order (PO) not properly scheduled, shipment arriving too early or too late, pallets loaded into a truck in the wrong sequence such that pallets which should be offloaded first are not located near the trailer door, etc.

In the example of FIG. 1, the computing device 102 represents any device executing computer-executable instructions 104 (e.g., as application programs, operating system functionality, or both) to implement the operations and functionality associated with the computing device 102. The computing device 102 in some examples includes a mobile computing device or any other portable device. A mobile computing device includes, for example but without limitation, a mobile telephone, laptop, tablet, computing pad, netbook, gaming device, and/or portable media player. The computing device 102 can also include less-portable devices such as servers, desktop personal computers, kiosks, or tabletop devices. Additionally, the computing device 102 can represent a group of processing units or other computing devices.

In some examples, the computing device 102 has at least one processor 106 and a memory 108. The computing device 102 in other examples includes a user interface component 110.

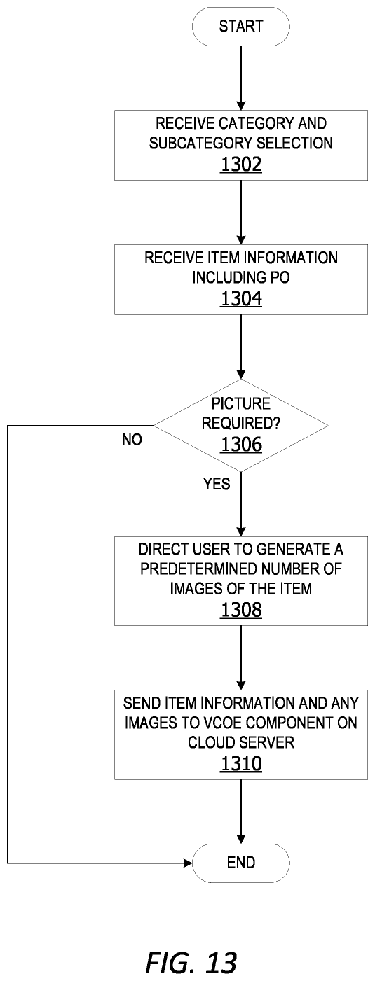

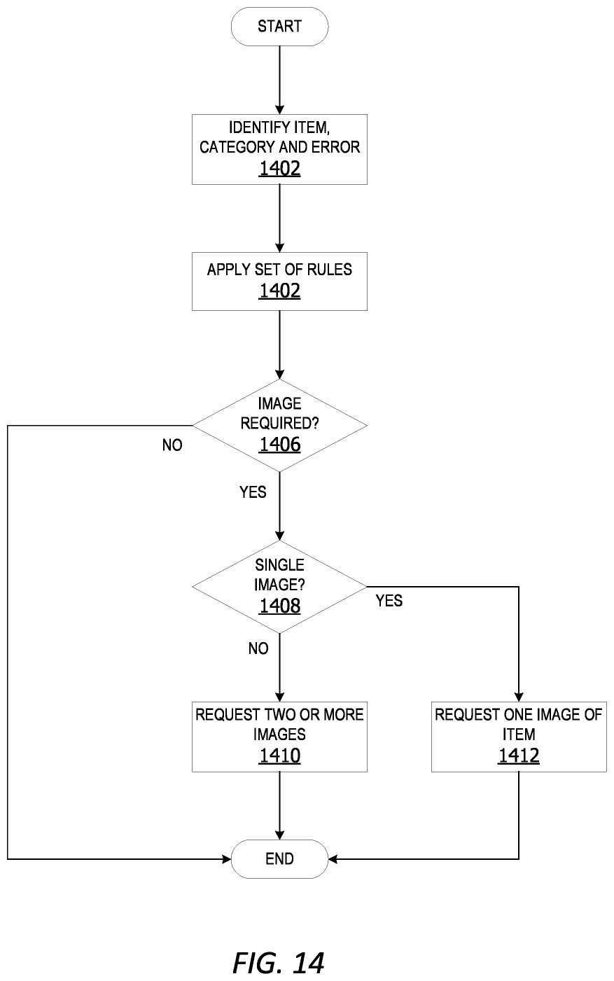

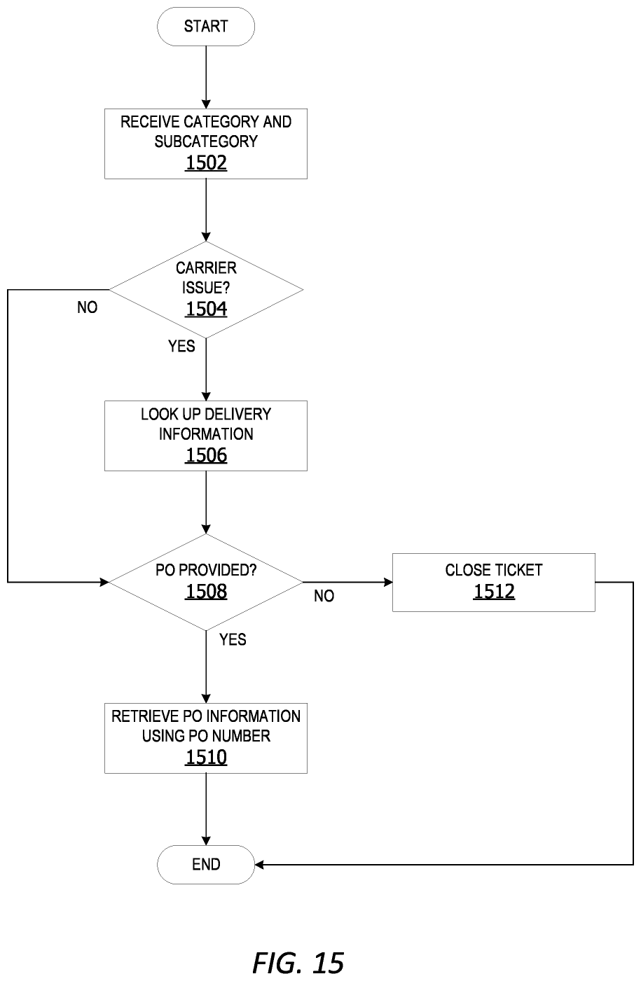

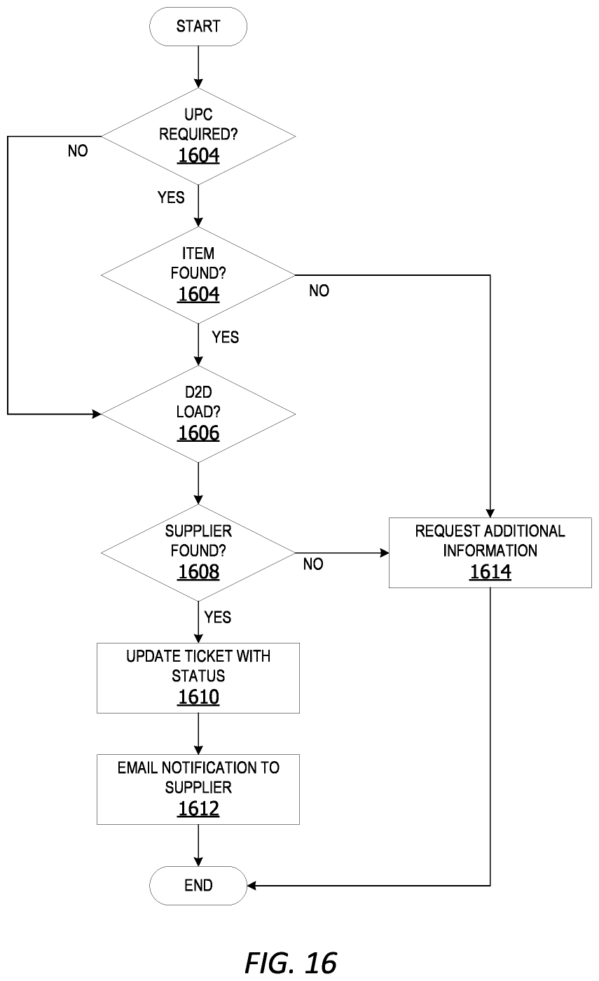

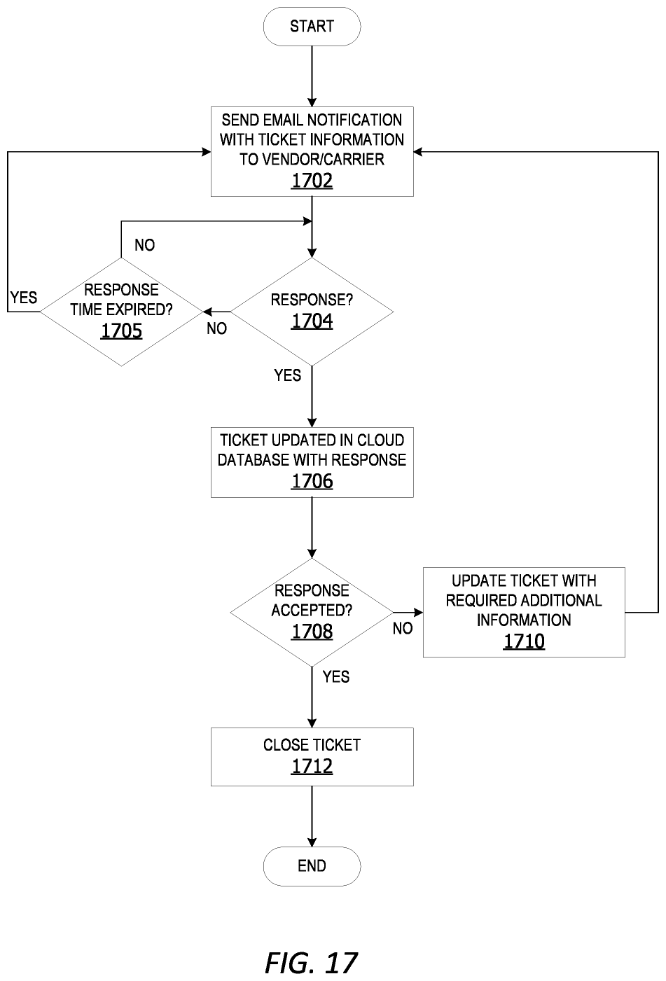

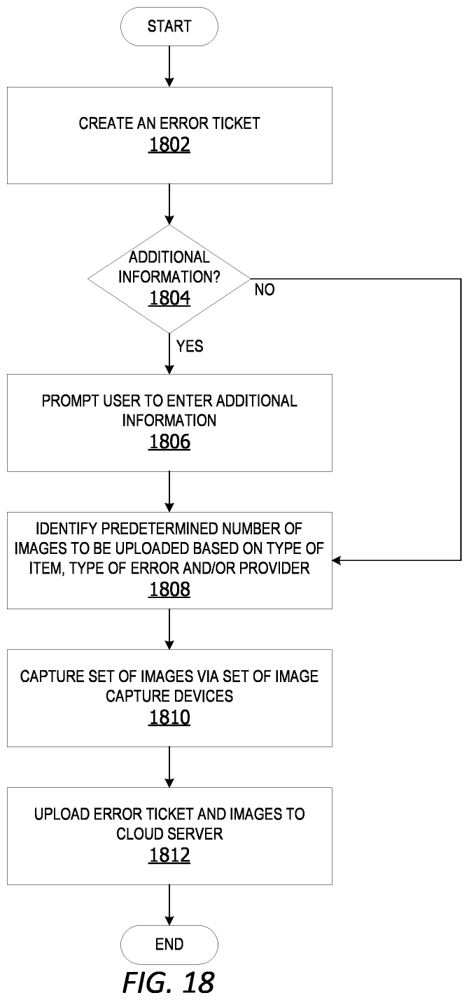

The processor 106 includes any quantity of processing units and is programmed to execute the computer-executable instructions 104. The computer-executable instructions 104 is performed by the processor 106, performed by multiple processors within the computing device 102 or performed by a processor external to the computing device 102. In some examples, the processor 106 is programmed to execute instructions such as those illustrated in the figures (e.g., FIG. 12, FIG. 13, FIG. 14, FIG. 15, FIG. 16, and FIG. 17).

The computing device 102 further has one or more computer-readable media such as the memory 108. The memory 108 includes any quantity of media associated with or accessible by the computing device 102. The memory 108 in these examples is internal to the computing device 102 (as shown in FIG. 1). In other examples, the memory 108 is external to the computing device (not shown) or both (not shown). The memory 108 can include read-only memory and/or memory wired into an analog computing device.

The memory 108 stores data, such as one or more applications. The applications, when executed by the processor 106, operate to perform functionality on the computing device 102. The applications can communicate with counterpart applications or services such as web services accessible via a network 112. In an example, the applications represent downloaded client-side applications that correspond to server-side services executing in a cloud.

In other examples, the user interface component 110 includes a graphics card for displaying data to the user and receiving data from the user. The user interface component 110 can also include computer-executable instructions (e.g., a driver) for operating the graphics card. Further, the user interface component 110 can include a display (e.g., a touch screen display or natural user interface) and/or computer-executable instructions (e.g., a driver) for operating the display. The user interface component 110 can also include one or more of the following to provide data to the user or receive data from the user: speakers, a sound card, a camera, a microphone, a vibration motor, one or more accelerometers, a BLUETOOTH® brand communication module, global positioning system (GPS) hardware, and a photoreceptive light sensor. In a non-limiting example, the user inputs commands or manipulates data by moving the computing device 102 in one or more ways.

The network 112 is implemented by one or more physical network components, such as, but without limitation, routers, switches, network interface cards (NICs), and other network devices. The network 112 is any type of network for enabling communications with remote computing devices, such as, but not limited to, a local area network (LAN), a subnet, a wide area network (WAN), a wireless (Wi-Fi) network, or any other type of network. In this example, the network 112 is a WAN, such as the Internet. However, in other examples, the network 112 is a local or private LAN.

In some examples, the system 100 optionally includes a communications interface component 114. The communications interface component 114 includes a network interface card and/or computer-executable instructions (e.g., a driver) for operating the network interface card. Communication between the computing device 102 and other devices, such as but not limited to 116 and the set of data sources 118, can occur using any protocol or mechanism over any wired or wireless connection. In some examples, the communications interface component 114 is operable with short range communication technologies such as by using near-field communication (NFC) tags.

The user device 116 represent any device executing computer-executable instructions. The user device 116 can be implemented as a mobile computing device, such as, but not limited to, a wearable computing device, a mobile telephone, laptop, tablet, computing pad, netbook, gaming device, and/or any other portable device. The user device 1161 includes at least one processor and a memory. The user device 16 can also include a user interface component.

In this example, the user device 116 includes an error handling component 120 for assisting a user 124 in creating an error ticket 122. The error handling component 120 outputs a set of prompts or fields prompting the user 124 to provide information associated with an item received in freight which appears to be associated with a non-damage related freight error. An error can include any type of non-conformity with a set of rules associated with the building, loading and/or shipping of items in cases and pallets.

The term item, as used herein, can refer to a single item as well as a case or box containing one or more items. An item can be a packaged item or an unpacked item. For example, a packaged item can be, without limitation, a box of shoes, package of soap, box of cereal or any other packaged item. An unpackaged item can include a piece of fruit, a bunch of romaine lettuce, a lawnmower, or any other type of item having minimal, limited or no packaging. Minimal packaging may include tags, labels, cardboard sleeves, etc. An item can also include a single package holding multiple instances of an item. For example, cans of soft drinks are frequently tied together via plastic rings. In another example, two cans of a product may be shrink-wrapped together to be sold or displayed as a single unit.

The error ticket 122 in some examples is an electronic document, object, table, or field including data associated with an error. The error ticket 122 can include information such as, an identification (ID) of the item, type of error, category of error, sub-category of the error, time the item was received, rule violation, etc. The error ticket 122 can optionally also include one or more images of the item included in the ticket or appended to the ticket. In some examples, different criteria are applied to determine error ticket handling and image requirements based on different categories, such as, for example, a product quality category versus load quality category.

The set of data sources 118 is a set of one or more sources of data associated with the received item having the detected error. The set of data sources 118 can include a database or any other type of data store. In some examples, set of data sources 118 provide received freight data 126 to the computing device 102. The received freight data 126 includes data associated with the received item, such as, but not limited to, a purchase order (PO), shipping manifest, delivery receipts, bill of lading or any other type of freight-related data.

The system 100 can optionally include a data storage device 128 for storing data, such as, but not limited to ticket data 130, aggregated error data 132 and/or response data 134. Ticket data 130 is data provided in an error ticket, such as the error ticket 122. Ticket data 130 can include, without limitation, item identification data from a barcode, label or other information, delivery data, carrier data, vendor data, error type, etc. The ticket data 130 can optionally include one or more images of the item.

Aggregated error data 132 is data from a plurality of error tickets which has been consolidated or aggregated together. Aggregated error data 132 in some examples is presented to a user in a summarized, indexed, or correlated form via a dashboard 136 presented to the user via the user interface component 110 on the computing device 102. In other examples, the dashboard 136 presents aggregated error data 132 to one or more users via a user interface on one or more remote computing devices, such as, but not limited to, the user device 116. One or more users monitors aggregated data on the dashboard and runs reports based on the aggregated data. The aggregated data can be used for management decisions, vendor, and carrier negotiations, identify number of offenses (noncompliant items or number of error tickets) per-provider, updating DC procedures, vendor and carrier selection, scheduling orders, etc.

The response data 134 is data identifying or recording a vendor, carrier, or DC response to an error alert 138 or other notification. In some examples, the response data 134 is utilized to determine if and/or when to close an error ticket. For example, if a satisfactory response to an error ticket issue has been received from a carrier or vendor, the error ticket 122 can be closed by the VCOE component 140. If no response has been received or a non-compliant response has been received, the error ticket can remain open. A non-compliant response is a response which does not conform to a response expected based on rules or an agreement with the carrier and/or vendor. A non-compliant response can also include a response which is different from a requested response or a complete lack of response.

The data storage device 128 can include one or more different types of data storage devices, such as, for example, one or more rotating disks drives, one or more solid state drives (SSDs), and/or any other type of data storage device. The data storage device 128 in some non-limiting examples includes a redundant array of independent disks (RAID) array. In other examples, the data storage device 128 includes a database.

The data storage device 128 in this example is included within the computing device 102, attached to the computing device, plugged into the computing device, or otherwise associated with the computing device 102. In other examples, the data storage device 128 includes a remote data storage accessed by the computing device via the network 112, such as a remote data storage device, a data storage in a remote data center, or a cloud storage.

The memory 108 in some examples stores one or more computer-executable components, such as, but not limited to, the VCOE component 140 and/or a notification component 143. In some examples, the VCOE component, when executed by the processor 106 of the computing device 102, receives one or more error tickets from one or more error handling components, such as, but not limited to, the error ticket 122 from the error handling component 120. The VCOE component 140 processes the error ticket 122 to obtain the ticket data 130. The VCOE component 140 requests additional information associated with the error from the set of data sources 118. The set of data sources 118 provides the additional received freight data 126 to the VCOE component 140 via the network 112.

The VCOE component 140 in other examples can request additional information from the error handling component 120 if any desirable information for resolving the error ticket is missing from the received ticket data 130. For example, if an image of the item is needed but the ticket data did not include an image, the image if from an undesirable angle, or the image is of poor quality (blurry, out of focus, etc.), the VCOE component 140 can send a request to the VCOE component 140 prompting the user to provide an additional photograph or digital image of the item.

The VCOE component 140 applies a set of rules, such as the set of rules 145 and/or the set of rules 152, to the ticket data 130 to identify an appropriate resolution or remedy for the detected issue. The set of rules can optionally include rules specifying appropriate remedies based on the type of item, location of the DC, ID of the vendor or carrier, predetermined remedy procedures, etc. For example, if a shipment of items arrives too early or too late, the remedy for one vendor may include requesting a change to the delivery date of the next shipment of additional instances the same item while a remedy for another vendor may include requesting a partial refund, requesting reduction in the number of instances of the same item to be received in the next shipment from the vendor, or rerouting the next expected shipment to a different DC location.

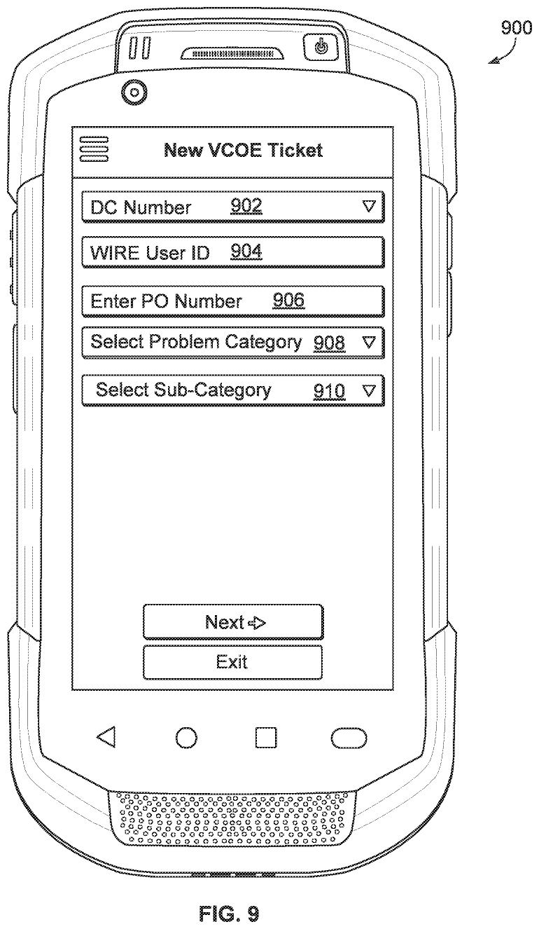

In other examples, the error handling component 120 creates the error ticket 122 associated with a detected non-damage related error in at least one received item at a point of origin based on a set of user-configurable rules 152. The set of rules 152 can be the same as the set of rules 145 or a different set of user-configurable rules on the user device 116. Where it is the same set of rules, the error handling component accesses the rules via the network 112. In other examples, the set of rules 152 is a local copy of the set of rules 145, which is stored on the user device 116. A user interface component on the user device, as shown in FIG. 8 below, prompts a user to enter additional information responsive to the set of rules 145 and/or the set of rules 152 indicating at least one item of additional information is desirable based on a type of the detected non-damage related error.

A rules engine identifies a pre-determined number of images of the received items to be uploaded with the error ticket based on at least one of a type of the received item, the type of the detected non-damage related error and/or a provider 150 associated with the received item. The error type 148, item type 146 and/or provider 150 are determined based on user-provided information in the error ticket, additional information requested from the user, information obtained by scanning a barcode or label on the item and/or information obtained from the set of data sources 118.

The rules engine in this example is a rules engine on the error handling component 120. In other examples, the rules engine is a rules engine on the VCOE component. The rules engine on the VCOE component sends the predetermined number of images required to the user device 116 which then prompts the user to generate the images using one or more image capture devices on the user device 116 or triggers a set of one or more image capture devices 142 at the point of origin to automatically generate images of the received item. The set of images 144 of the received item including the pre-determined number of images. The error handling component 120 uploads the error ticket with the set of images 144 to the VCOE component.

The notification component in the example shown in FIG. 1 is separate from the VCOE component. However, in other examples, the VCOE component includes the notification component.

In this example, the error handling component is implemented on the user device 116 while the VCOE component and the notification component are implemented on the computing device 102. However, the examples are not limited to implementation on two different computing devices. In other examples, both the error handling component creating the error ticket and the VCOE component resolving the error ticket can be implemented on the same computing device 102. Likewise, both the error handling component and the VCOE component in other examples can be implemented on a cloud server.

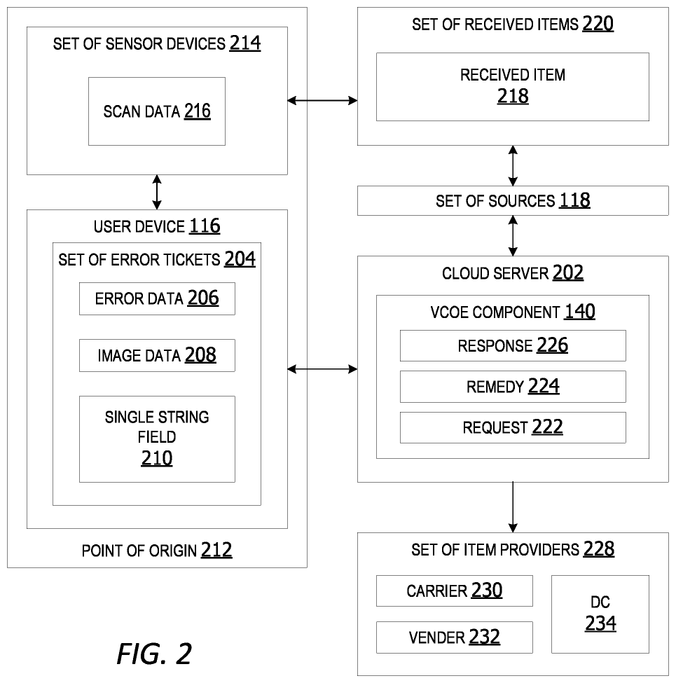

FIG. 2 is an exemplary block diagram illustrating a system 200 including a VCOE component 140 on a cloud server 202 for handling errors in received freight. The cloud server 202 is a logical server providing services to the user device 116 or other clients. The cloud server 202 is hosted and/or delivered via a network, such as, but not limited to, the network 112 in FIG. 1. In some non-limiting examples, the cloud server 202 is associated with one or more physical servers in one or more data centers. In other examples, the cloud server 202 is associated with a distributed network of servers.

The VCOE component 140 in some examples receives a set of error tickets 204 from a user device 116. The set of error tickets 204 includes one or more error tickets, such as, but not limited to, the error ticket 122 in FIG. 1. The set of error tickets 204 includes error data 206 describing the issue associated with a received item 218 in a set of received item 220 of the received freight. In some examples, the set of error tickets optionally include image data including one or more images of the received item 218. The Error handling component on the user device in other examples, provides the error data in a single string field 210 for parsing by the VCOE component 140.

The system 200 in other examples permits the user to create an error ticket at a point of origin 212 of the issue associated with the received freight. The point of origin in some examples is a DC. In other examples, the point of origin may include a retail store, a warehouse, or a receiving station, building, storeroom, or kiosk for receiving goods.

The point of origin 212 in this non-limiting example is a location at the DC at which the error associated with the item is identified. In some examples, the point of origin 212 is an area at the DC at which the pallets, cases or items are unloaded from a truck or trailer. In other examples, the point of origin is a de-palletizing area of the DC in which pallets are broken down to remove items or cases of items from the pallet.

If an image of the item is desired, the Error handling component outputs a prompt to the user to capture of an image of the item using an image capture device. The image capture device can be implemented as a camera on the user device 116, a set of one or more cameras in the DC or any other image capture device. In other examples, the Error handling component automatically triggers capture of an image of the item via one or more cameras inside or outside the DC. The cameras automatically upload the captured images to the Error handling component and/or the VCOE component.

In some examples, a set of sensor devices 214 associated with the DC captures scan data 216 associated with the received item 218. The set of sensor devices 214 in some examples includes a set of one or more scan devices, a set of one or more radio frequency identifier (RFID) tag readers and/or a set of one or more image capture devices. The set of sensor devices 214 can include one or more sensor devices located inside the DC as well as one or more sensor devices located outside the DC. One or more sensor devices in the set of sensor devices may optionally also be located on one or more user devices, such as, but not limited to, the user device 116.

An image capture device may include an analog camera, a digital camera, an IR camera, or other type of camera. A camera provides real-time imaging of the one or more item(s) and/or data recording. The one or more infrared (IR) cameras optionally enable infrared thermography to generate accurate, automated non-contact temperature measurements of item(s). This provides more non-contact data generation associated with items received at the DC or other location. In this manner the system 200 can autonomously generate image data 208 via automated cameras at the point of origin without human user intervention.

The Error handling component on the user device 116 uploads the set of error tickets with any available image data 208 and/or scan data 216 to the VCOE component 140. The VCOE extracts error data 206 from the set of error tickets 204. If additional information is required for error handling by the VCOE component, the VCOE component 140 sends a request 222 for the additional information back to the user device 116.

For example, if another image of the item is desirable, the request 222 for one additional image is sent to the user device and output by the Error handling component to the user via a user interface on the user device 116. In one example, the request can include details such as a suggested angle, side, or viewpoint for the additional image(s).

Other additional information associated with the received item can optionally be obtained from one or more data sources in the set of data sources 118. The additional information in some examples includes PO data, delivery data, carrier information, etc.

The VCOE component analyzes the error data extracted from the set of tickets 204 using a set of user-configurable rules to determine an appropriate remedy 224. The remedy 224 is included within a notification alert which is sent to a set of one or more providers 228. The notification alert is a message, such as, but not limited to, the alert 138 in FIG. 1.

The set of item provides 228 is a set of one or more carriers, vendors, and/or other information associated with the provider of the received item 218. The provider of the received item 218 can include a vendor 232, such as a manufacturer. A provider in other examples can include a carrier 230 shipping or transporting the item to the point of origin 212. The provider can also include another DC 234 if the received item was sent from one DC to another receiving DC.

The remedy 224 in some examples includes an instructed or recommended action to remedy the issue, feedback, a response time (time period for responding), and/or other information associated with resolving the issue. If the provider provides a response 226 to the VCOE component 140, the VCOE component 140 updates the error ticket with the response data. If the response 226 includes providing the requested remedy 224 within the requested response time, the VCOE component 140 can close the error ticket or set of error tickets associated with the response 226.

In this example, the set of error tickets includes one or more tickets associated with a single received item 218. In other examples, a set of error tickets includes multiple error tickets associated with multiple items received from a common provider. For example, if received freight includes multiple errors associated with multiple items from the same vendor or the same carrier, the set of error tickets may be resolved via a single alert notification including a request 222 to the single vendor 232 or carrier 230 requesting a remedy 224 encompassing all the error issues associated with all the multiple items received from that vendor or carrier. In other examples, a separate alert notification is sent to the vendor for each separate item error issue. In these examples, multiple notifications may be sent to the same vendor if there are multiple different issues affecting multiple different items received from the same vendor or carrier.

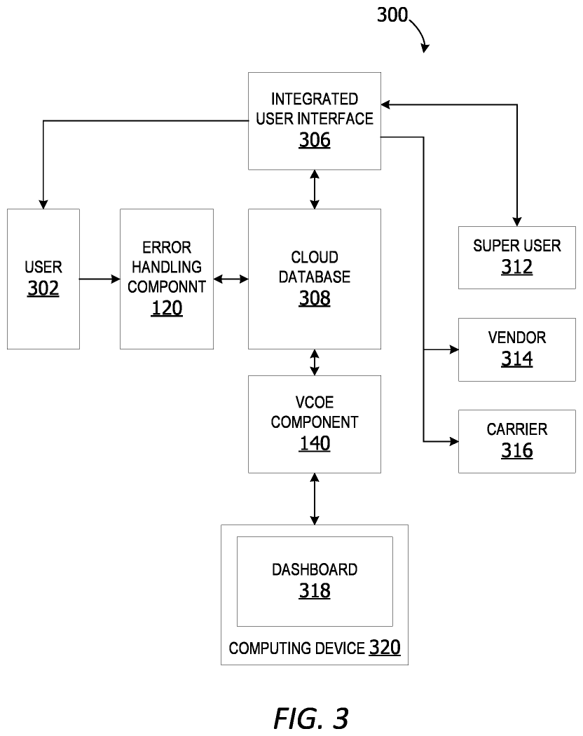

FIG. 3 is an exemplary block diagram illustrating a system 300 including a cloud database for handling errors in received freight. A user 302 in some examples utilizes the mobile error handling component 120 via a user device to create an error ticket describing non-damage related errors in received freight. An integrated user interface 306 optionally permits users, such as the user 302 and/or a super user 312, to update and create error tickets.

The super user 312 optionally utilizes the integrated user interface 306 to reconfigure the set of rules utilized to handle and resolve error tickets. In some examples, a re-configurable rules engine is in the cloud which allows business super users to alter the rules as the needs of the business change. Rules include when a photo is required based upon the nature of the error detected.

In some examples, the error handling component includes an android front-end for limited data collection based on configurations set up in a cloud database. The error handling component uploads the error ticket created by the user 302 to the cloud database 308 for further handling and routing. In some examples, the data from the front-end error handling component is passed to the cloud database, which is also used to manage the rules-engine, configuration, notifications, and user dashboards.

The VCOE component 140 retrieves the ticket data from the cloud database 308 for error handling. In some examples, the VCOE component 140 includes a workflow engine which collects, processes, cleanses, enhances, and adds to the data collected from the user at the error handling component. The workflow also uses rules to determine when a ticket must be closed or requires more detail, etc.

In other examples, the VCOE component 140 generates notification(s) which are sent to a vendor 314 and/or a carrier 316. The notification(s) are output to the vendor 314 and/or the carrier 316 via a user interface, such as, but not limited to, the integrated user interface 306. The notification(s) include a suggested or recommended remedy (action) to be performed by the vendor or carrier to resolve the remedy ticket.

Aggregated error data obtained from a plurality of error tickets generated by a plurality of users at one or more different points of origin (DCs) are processed to generate summaries, charts, graphs, and reports associated with freight errors associated with multiple vendors, carriers and DCs. The aggregated data is presented to users via a dashboard 318 via a computing device 320. The computing device 320 is a computing device such as, but not limited to, the computing device 102 or the user device 116 in FIG. 1.

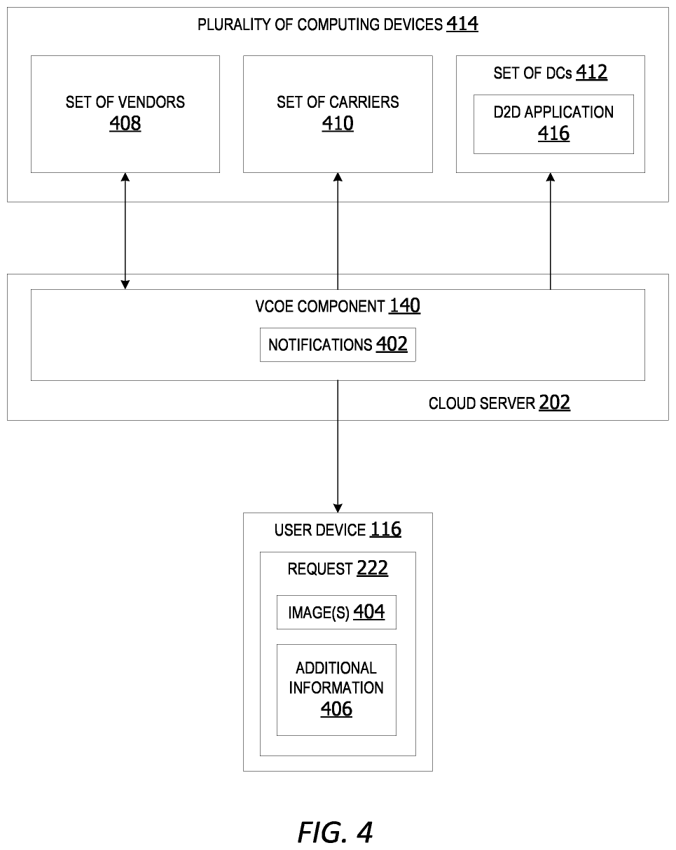

FIG. 4 is an exemplary block diagram illustrating a system 400 including a VCOE component 140 generating alert notifications 402 to one or more item providers. A notification in the one or more notifications 402 is an alert notification, such as, but not limited to, the alert 138 in FIG. 1. The notification can include ticket data, error data describing the issues, item data describing the item involved, feedback from one or more users, a proposed remedy (action to be taken), a time-period for performing or completing the remedy, or other data associated with resolving the issue.

In some examples, a notification in the notifications 402 include a request 222 for additional information sent to the user device 116 which originated or created the error ticket. The additional information request 222 can include a request for one or more image(s) 404 of the received item associated with the error and/or any other additional information 406 associated with the received item. The additional information 406 requested can include, for example but without limitation, a user description of the item, user description of the condition of the item, user identification of the type of item, barcode number, number of items involved, time of receipt, location at which the item was received, etc.

The one or more alert notifications 402 are sent to a set of one or more vendors 408, a set of one or more carriers 410 and/or a set of one or more DCs 412. The notifications are transmitted to one or more computing devices in a plurality of computing devices associated with the set of vendors 408, the set of carriers 410 and/or the set of DCs 412. In some examples, notifications for another DC are sent to a D2D application 416 associated with the provider DC that sent the received item to the receiving DC in a DC-to-DC transaction.

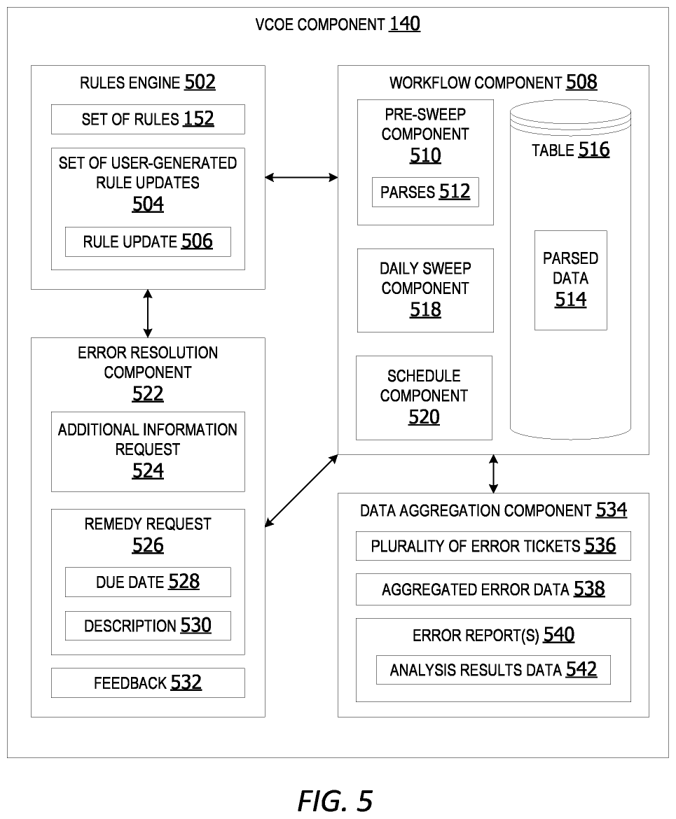

FIG. 5 is an exemplary block diagram illustrating a VCOE component 140 for processing and handling error tickets. In some examples, a rule engine 502 component utilizes the set of rules 152 for handling and resolving one or more error tickets. A user can update or reconfigure the rules to respond to changes in policy, laws, contract terms, goals, or any other reason. The set of user-generated rule updates 504 provided by one or more authorized users enables real-time rule update 506.

A workflow component 508 in some examples includes a pre-sweep component 510. The pre-sweep component 510 performs pre-processing of incoming error ticket data. The pre-sweep component 510 parses 512 the ticket data and stores the parsed data 514 in a table 516 for additional processing.

A daily sweep component 518 in other examples performs additional analysis on the parsed data 514 using the set of rules 152 to determine how to resolve or dispose of each error ticket.

A schedule component 520 in some examples, prevents unparsed data from error tickets from being processed by the daily sweep component 518.

An error resolution component 522 optionally requests additional information from a set of data sources and/or from the Error handling component originating the error ticket, if such additional information is necessary. In some examples, the error resolution component 522 generates an additional information request 524 which can be sent to the user device or the set of data sources via a network connection.

A remedy request 526 in some examples is a request included in an alert notification providing details regarding a recommended or required remedy. The remedy request 526 can include, for example but without limitation, a due date 528 for the vendor or carrier to perform the remedy, a description of the remedy 530 and/or feedback 532 associated with the error and/or the remedy.

In some examples, a data aggregation component 534 generates aggregated error data 538 based on error data extracted or otherwise obtained from a plurality of error tickets 536 and information associated with resolution of those error tickets. The aggregated error data 538 is analyzed and processed to generated error report(s). The analysis results data 542 may be presented in the error report(s) in the form of data summaries, charts, graphs, tables, or any other form. The aggregated error data is presented to users via a user interface dashboard, such as, but not limited to, the dashboard 136. In other examples, the aggregated error data 538 and/or the error report(s) 540 are output to one or more users via email, printouts, audio output, graphical output, haptic output, or any other type of output.

In this example, the dashboard is provided via a computing device, such as, but not limited to, the computing device 102 in FIG. 2. In other examples, the dashboard 136 can be provided via a user interface on a user device, such as, but not limited to, the user device 116 in FIG. 1.

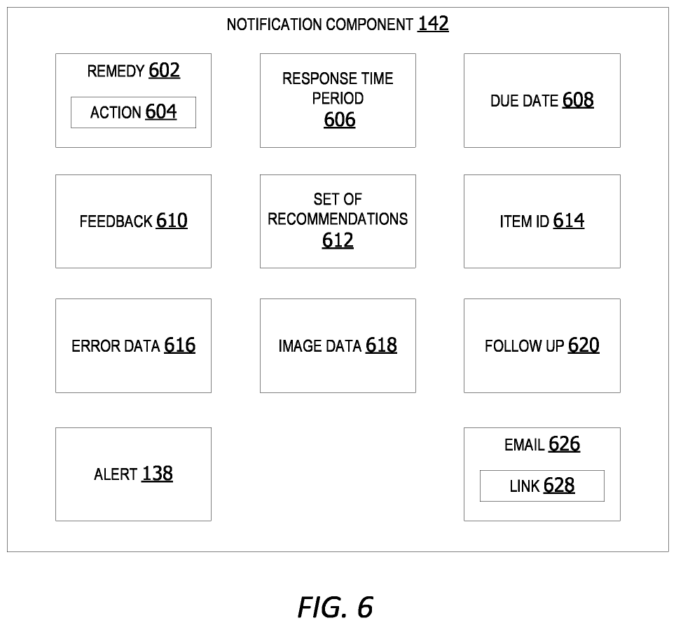

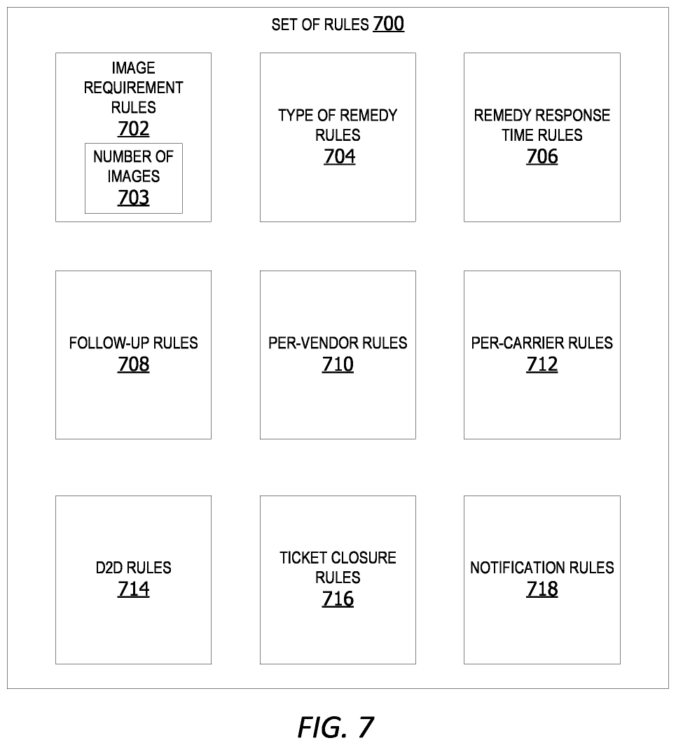

FIG. 6 is an exemplary block diagram illustrating a notification component 143 for generating alert 138 notifications. The notification component 143 generates an alert 138 which can optionally include an identification of a desired remedy 602, such as, but not limited to, an action 604 to be taken by the vendor, carrier, or provider DC. The alert 138 can include a response time period 606 and/or a due date 608 at which the remedy action should be completed by the vendor, carrier, or DC. The alert notification can optionally include feedback 610 from the receiving DC and/or a set of one or more recommendations for preventing or avoiding future errors.

In some examples, the feedback include the DC-to-DC feedback as when a vendor delivers goods to an import site which transfers these to a regional distribution center (RDC). The RDC may detect errors and report these to the import site or the vendor. The rules engine determines the erring party (responsible provider) based upon the category of the error. The system sends alerts to one or more users, such as a manager, when exceptions are encountered.

The notification alert 138 in other examples includes an item ID 614 identifying the received item associated with the error issue, error data 616 describing the error, and/or image data 618 including one or more images of the received item. The item ID in some examples includes an identification number typically found on the outside of a case which identifies the case.

If the remedy 602 if not performed within the response time period 606 or by the due date 608, the notification component can send a follow up 620 message reminding the carrier, vendor, or provider DC of the unresolved error ticket related issue.

The alert 138 notification and/or the follow up 620 message in some examples is sent as an email 626. The email can include a link to the image data 618 and/or other relevant information associated with the error. In still other examples, the image data 618 is included in the notification alert 138 sent to the vendor, carrier, or provider DC.

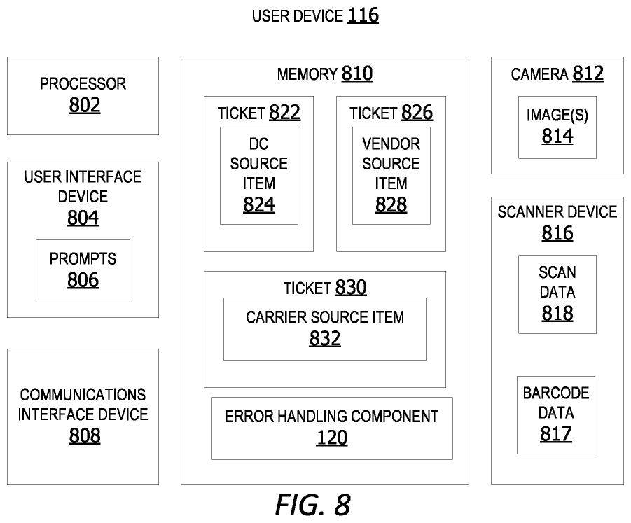

FIG. 7 is an exemplary block diagram illustrating a set of rules 152 for handling error tickets. The set of rules 152 is a user-configurable set of rules. In some examples, the set of rules include one or more if-then statements for determining proper handling and resolution of errors.

The set of rules 152 in some examples includes a set of one or more image requirement rules 702 for determining when one or more images of the received item should be submitted with the error ticket. The predetermined number of images 703 is the number of images to be uploaded with an error ticket. In some examples, the rules specify whether no image is required, a single image is required or two or more images are required to be submitted based on the type of item, vendor, carrier, type of error or issue, and other factors. Thus, the number of images 703 can be a null set requiring no images, one image, two images, as well as three or more images.

In other examples, the number of images can also specify angles or sides of the item, as well as locations in which the images should be taken. For example, the rules may specify one image of the front of an item and another image of the back. If the error is a pallet loading error, the rules may specify an image of the pallet on the truck be uploaded along with another image of the pallet after unloading from the truck, etc.

A set of one or more type of remedy rules 704 are provided in some examples for identifying suitable remedies for error tickets based on the error data. Remedy response time rules 706 include one or more rules for setting a response time interval or response due date in an alert notification. Follow up rules 708 include one or more rules for determining if and when to send a follow-up notification to a vendor, carrier, or provider DC when a response to the initial alert notification is not received within the response time or by the due date.

In some examples, the set of rules 152 includes per-vendor rules 710. The per-vendor rules 710 include one or more rules which are applicable to items received from one or more vendors. In other words, the per-vendor rules 710 are specialized to a selected vendor. Per-carrier rules 712 include one or more rules specific to one or more selected carriers. The D2D rules 714 include one or more rules for resolving issues associated with items received by one DC from another DC.

Ticket closure rules 716 in other examples include one or more rules specifying when to close an error ticket. In some examples, the ticket closure rules 716 state that a ticket should be closed when a remedy specified in an alert notification sent to a vendor or carrier is performed or completed within the specified response time.

In still other examples, the set of rules 152 includes one or more notification rules 718. Notification rules 718 are used by the VCOE component to determine when to send an alert notification to a carrier, vendor, or provider DC.

FIG. 8 is an exemplary block diagram illustrating a user device 116 hosting an error handling component 120 for creating error tickets. The user device 116 in some examples includes one or more processors, such as, but not limited to, the processor 802. A user interface device 804 provides a series of prompt(s) 806 or fields for the user to provide relevant information associated with each detected error in freight received at the point of origin, such as, but not limited to, a DC.

A communications interface device 808 enables the user device to send data to the VCOE component on the cloud server via a network. The user device can optionally also receive requests for additional information from the VCOE component via the network.

A memory 810 stores data, such as, but not limited to, the error handling component and/or ticket data. The error handling component generates error tickets based on error data input by the user and/or one or more image(s) 814 generated by a camera 812 or another image capture device. The camera 812, in this example, is incorporated into the user device 116. In other examples, the camera 812 is located exterior to the user device 116.

The user device 116 can optionally include a scanner device 816 such as, but not limited to, a barcode scanner. The barcode scanner can include a device for scanning a matrix barcode, a universal product code (UPC), or any other type of barcode. The scanner device 816 generates scan data 818 and/or barcode data 817 identifying the item.

In some non-limiting examples, the system includes five-sided scanners in the network. When the scanner detects an error, the scanner captures images (photographs) of the offending product and sends this and other information to the cloud database. If the system requires additional information about the error, an alert is sent to the site where a user can follow up.

In some examples, the error handling component generates a ticket 822 for a DC source item 824. The DC source item 824 is an item received at a DC from another DC. The error handling component can also generate a vendor source item 828 ticket 826 or a carrier source item 832 ticket 830. A vendor source item 828 is a received item associated with a non-damage issue that is received from a vendor or the issue is otherwise related to the vendor. The alert notification in this example is submitted to the vendor for remediation or resolution of the issue.

The carrier source item 832 is an item received from a carrier. The alert notification, including a recommended or requested remedy is submitted to the carrier for remediation of the issue.

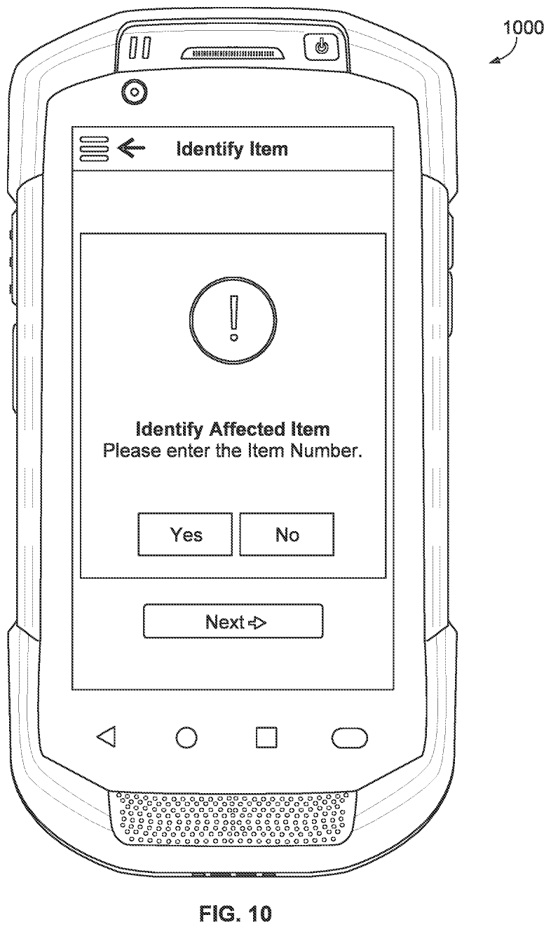

FIG. 9 is an exemplary block diagram illustrating a screenshot 900 of a user device including a display having fields associated with creating an error ticket. The error handling component outputs a set of fields to the user via the user interface to prompt the user to enter information required for resolving the error ticket. In this non-limiting example, the user interface include a DC number 902 field for receiving a number identification the point of origin DC receiving the non-compliant item associated with the error issue. Once a user enters the DC number, the number is cached on the user device so the user does not have to re-enter that number next time the user creates a new error ticket.

A user ID 904 field prompts the user to provide the user's ID number. The user ID 904 identifies the user creating the error ticket.

The user can enter the purchase order number at an enter PO number 906 field. The select problem category 908 field enables the user to enter a problem category. The available categories for user selection vary depending on the type of DC. In other words, different DCs receive or store different types of items. One DC may receive grocery-related items, another DC may receive general merchandise only or both grocery and general merchandise. Thus, the fields for selection under the category field are customized based on the DC number. The categories can include loading errors, pallet build errors, packaging, or labeling errors, etc.

A select sub-category 910 field enables the user to provide a sub-category for the type of error. If the category is a pallet build problem, the sub-category can include overhanging items on the pallet, incorrect sequence of items on the pallet, incorrectly wrapped pallet, no wrap on the pallet, incorrect tension on the pallet wrap, etc. Likewise, if the category is labeling error, the sub-categories can include fields for missing labels, torn labels, illegible or smudged labels, incorrect labels, missing barcodes, illegible barcodes, inaccurate barcodes, etc. If the category is loading error, the sub-category can include incorrect placement of pallet on the truck, pallets fallen over, shifted pallets inside the truck, improperly secured pallets, etc.

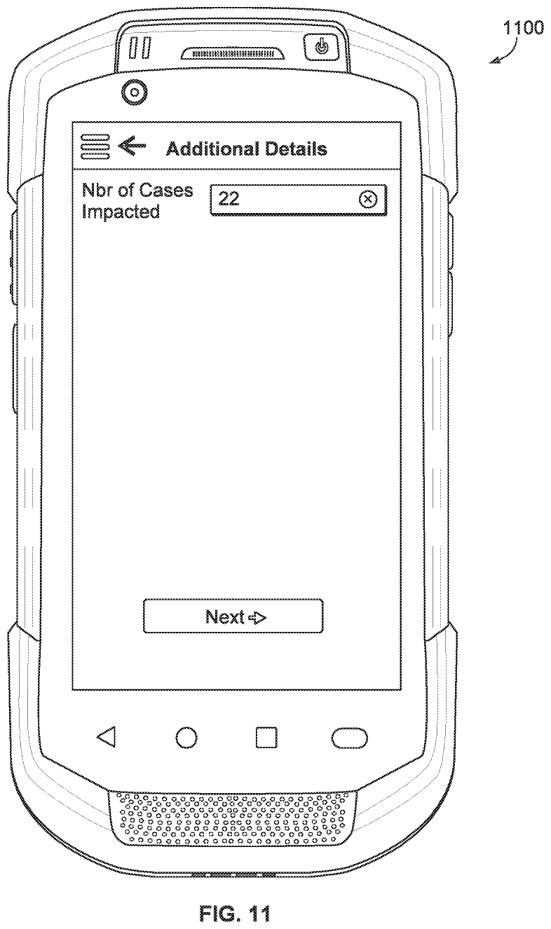

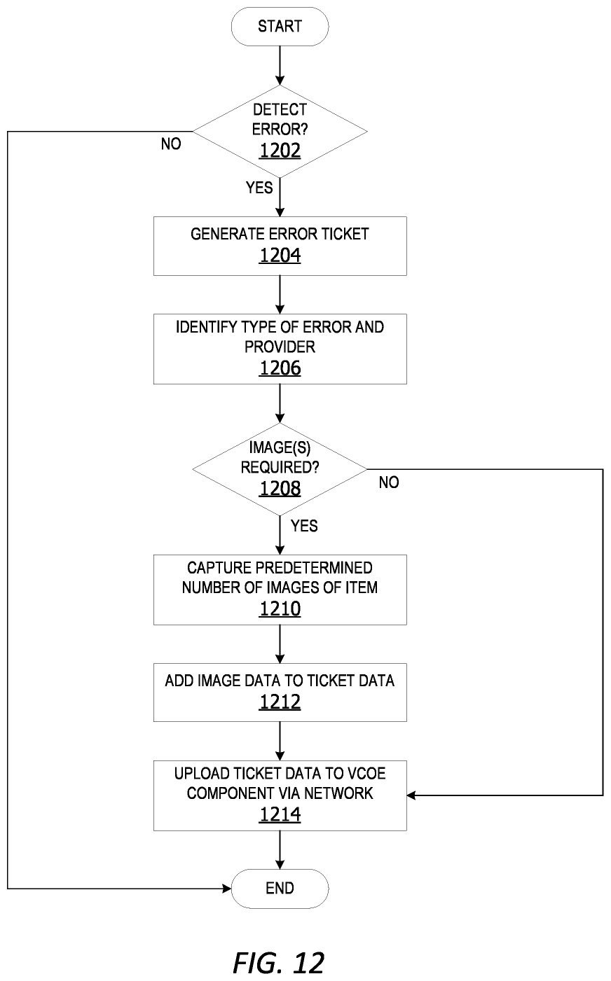

FIG. 10 is an exemplary block diagram illustrating a screenshot 1000 of a user device including a display associated with identifying an item affected by a non-damage related error. Referring now to FIG. 11, an exemplary block diagram illustrating a screenshot 1100 of a user device including a display associated identifying items affected by an error is shown. The user is prompted to indicate the number of cases or items on a given pallet that have been impacted by the incorrect pallet build error.

FIG. 12 is an exemplary flow chart illustrating operation of the computing device to generate and upload an error ticket to a VCOE component. The process shown in FIG. 12 is performed by an error handling component, executing on a computing device, such as the computing device 102 or the user device 116 in FIG. 1.

The process begins by determining whether an error in received freight is detected at 1202. If yes, an error ticket is generated at 1204. A determination is made whether an image of the item is required at 1208. The determination is made based on one or more rules, such as the set of rules 152 in FIG. 1. If one or more images is required, the predetermined number of images of the item are captured at 1210. The images may be captured by a human user manually using a camera to generate digital images of the item. The images may also be generated automatically by one or more automated camera devices which upload the images to the VCOE autonomously.

The image data associated with the one or more images are added to the ticket data at 1212. The ticket data is uploaded to the VCOE component on the cloud server via a network at 1214. The process terminates thereafter.

While the operations illustrated in FIG. 102 are performed by a computing device, aspects of the disclosure contemplate performance of the operations by other entities. In a non-limiting example, a cloud service performs one or more of the operations. In another example, one or more computer-readable storage media storing computer-readable instructions may execute to cause at least one processor to implement the operations illustrated in FIG. 12.

FIG. 13 is an exemplary flow chart illustrating operation of the computing device to guide a user via a user interface in generating an error ticket via the Error handling component. The process shown in FIG. 13 is performed by an error handling component, executing on a computing device, such as the computing device 102 or the user device 116 in FIG. 1.

The process begins by receiving a category and subcategory selection for the type of error at 1302. The item information, including PO, is received at 1304. A determination is made whether the picture is required at 1306. If yes, the Error handling component directs the user to generate a predetermined number of images of the item at 1308. The Error handling component sends the item information and any images to the VCOE component on the cloud server at 1310. The process terminates thereafter.

While the operations illustrated in FIG. 13 are performed by a computing device, aspects of the disclosure contemplate performance of the operations by other entities. In a non-limiting example, a cloud service performs one or more of the operations. In another example, one or more computer-readable storage media storing computer-readable instructions may execute to cause at least one processor to implement the operations illustrated in FIG. 13.

FIG. 14 is an exemplary flow chart illustrating operation of the computing device to request images based on a set of rules. The process shown in FIG. 12 is performed by an error handling component, executing on a computing device, such as the computing device 102 or the user device 116 in FIG. 1.

The process begins by identifying the item, category, and error at 1402. The set of rules are applied at 1404 to determine whether an image is required at 1406. If yes, a determination is made as to whether a single image is required at 1408. If no, the Error handling component requests two or more images of the item at 1410. If a single image is required at 1408, the Error handling component requests one image of the item for upload at 1412. The process terminates thereafter.

While the operations illustrated in FIG. 14 are performed by a computing device, aspects of the disclosure contemplate performance of the operations by other entities. In a non-limiting example, a cloud service performs one or more of the operations. In another example, one or more computer-readable storage media storing computer-readable instructions may execute to cause at least one processor to implement the operations illustrated in FIG. 14.

FIG. 15 is an exemplary flow chart illustrating operation of the computing device to retrieve additional information for an error ticket based on user-provided data. The process shown in FIG. 12 is performed by a VCOE component, executing on a computing device, such as the computing device 102 or the user device 116 in FIG. 1.

The process begins by receiving category and subcategory for an error at 1502. The category and subcategory are provided in the error ticket uploaded by the Error handling component. The VCOE component determines whether the issue is a carrier issue at 1504. If yes, the system looks up delivery information at 1506. The delivery information can be obtained from a set of data sources, such as the set of data sources 118 in FIG. 1. The VCOE component workflow determines whether a PO is provided at 1508. If yes, the system retrieves the PO information using the PO number at 1510. If no, the error ticket is closed at 1512. The process terminates thereafter.

While the operations illustrated in FIG. 15 are performed by a computing device, aspects of the disclosure contemplate performance of the operations by other entities. In a non-limiting example, a cloud service performs one or more of the operations. In another example, one or more computer-readable storage media storing computer-readable instructions may execute to cause at least one processor to implement the operations illustrated in FIG. 15.

FIG. 16 is an exemplary flow chart illustrating operation of the computing device to handle an error ticket in accordance with one or more user-configured rules. The process shown in FIG. 12 is performed by a VCOE component, executing on a computing device, such as the computing device 102 or the user device 116 in FIG. 1.

The process begins by determining whether a UPC is required at 1602. If yes, a determination is made whether the item is found at 1604. If yes, a determination is made whether the item is a DC to DC (D2D) load at 1606. A determination is made whether the supplier is found at 1608. If yes, the ticket is updated with status at 1610. The alert notification alert is emailed to the supplier at 1612. The process terminates thereafter.

Returning to 1608, if the supplier is not found at 1608, the VCOE component sends a request for additional information to the Error handling component at 1614. The process terminates thereafter.

While the operations illustrated in FIG. 16 are performed by a computing device, aspects of the disclosure contemplate performance of the operations by other entities. In a non-limiting example, a cloud service performs one or more of the operations. In another example, one or more computer-readable storage media storing computer-readable instructions may execute to cause at least one processor to implement the operations illustrated in FIG. 16.

FIG. 17 is an exemplary flow chart illustrating operation of the computing device to determine whether to close an error ticket. The process shown in FIG. 12 is performed by a VCOE component, executing on a computing device, such as the computing device 102 or the user device 116 in FIG. 1.

The process begins by sending an email notification with error ticket information to a vendor or carrier at 1702. A determination is made whether a response is received at 1704. If no, a determination is made whether the response time is expired at 1705. If no, the system waits for a response until the response time is expired. The VCOE component sends another email notification to the vendor or carrier regarding the unresolved error ticket.

If a response is received from the carrier or vendor at 1704, the VCOE component updates the error ticket in the cloud database with the response at 1706. A determination is made whether the response is accepted at 1708. If no, the ticket is updated with the additional information at 1710. An email notification with the ticket information is sent to the vendor or carrier as a follow-up at 1702. If the response is accepted at 1708, the ticket is closed at 1712. The process is terminated thereafter.

While the operations illustrated in FIG. 17 are performed by a computing device, aspects of the disclosure contemplate performance of the operations by other entities. In a non-limiting example, a cloud service performs one or more of the operations. In another example, one or more computer-readable storage media storing computer-readable instructions may execute to cause at least one processor to implement the operations illustrated in FIG. 17.

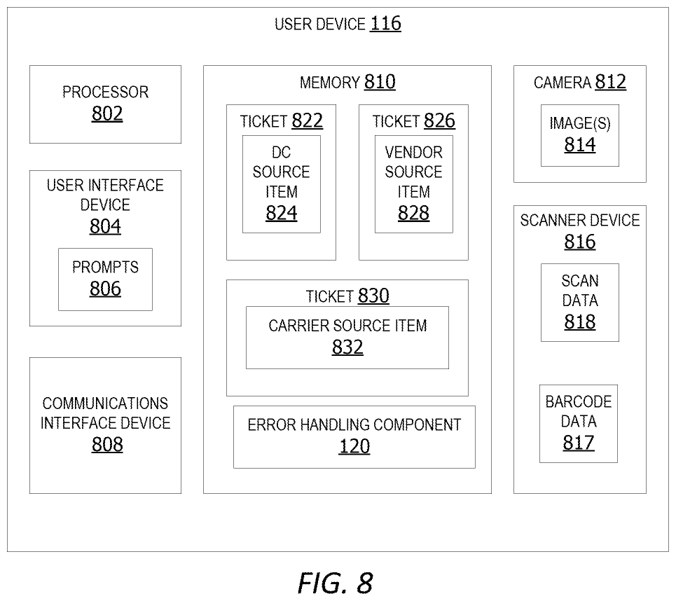

FIG. 18 is an exemplary flow chart illustrating operation of the computing device to utilizes a set of rules to generate an error ticket for non-damage related errors in received freight. The process shown in FIG. 18 is performed by an error handling component, executing on a computing device, such as the computing device 102 or the user device 116 in FIG. 1.

The process begins by creating an error ticket at 1802. A determination is made whether additional information from the user is required at 1804. The determination is made based on application of a set of rules, such as the set of rules 152. If yes, a user interface prompts the user to enter the additional information at 1806. The additional information may include, for example, description of the item, description of the error, ID of the user, ID of the item, case number, pallet number, carrier, item condition, category of error, sub-category of the error, etc.

The error handling component identifies a pre-determined number of images of the received item to be uploaded with the error ticket based on the type of item, the type of error, and/or the provider at 1808. The number of images are determined based on one or more rules in the set of rules. The pre-determined number of images of the item are captured by a set of image capture devices at 1810. The error ticket and the set of images are uploaded to a cloud server at 1812. The cloud server is a server, such as, but not limited to, the cloud server 202 in FIG. 2. A VCOE component in some examples on the cloud server processes the error ticket and takes appropriate action to resolve the error ticket. The process terminates thereafter.

### ADDITIONAL EXAMPLES

In some examples, the VCOE system on a cloud server receives error tickets created by a user via a front-end application. The ticket is processed through a workflow to determine if the error is a vendor issue, a carrier issue, or an issue originating from another DC in a DC-to-DC shipment. The workflow determines if the information submitted by user is valid. If the error ticket is a non-valid ticket, it is denied and the ticket is closed.

In other examples, the workflow processes or parses the ticket data to extract pertinent information which is placed into a single string field. The parsed data is processed to identify the appropriate provider responsible for the error. The provider may be a vendor, carrier, or DC. A notification alert regarding the error is sent to the provider. If no response is received from the provider, a follow-up notification is sent to the provider. Data regarding the error, including responses or failure to respond to the alert notification by the provider is recorded in a table. A set of rules are applied to the data in the table to determine the appropriate next action to take with regard to the error. The next action can include closing the ticket, sending a notification to a provider, sending an alert to a manager or other personnel, sending an update to a D2D application, etc. The rules-based system utilizes the set of rules to make decisions regarding handling and resolving errors without human intervention.

In a non-limiting scenario, an issue with a received item is identified by a user or by an automated system based on analysis of sensor data associated with received items at a point of origin, such as a DC. An error ticket is created and processed. A notification is sent to the provider. The notification includes a link to image or other additional information associated with the error. If a response is not received within a predetermined time-period, a follow-up notification is sent to the same provider. After another predetermined wait time, if no response is received from the provider, a notification is sent to a human user to manually pursue resolution of the issue. The predetermined wait time can be any user configurable time-period, such as, but not limited to, a week, five business days, two weeks, ten business days, etc.

In some examples, the set of data sources includes an order management system providing PO and delivery data associated with received items. This permits faster and more accurate data pulls directly from the source rather than from an aggregate (teradata) data pool. The system can further send and receive data from multiple receiving centers (DCs, warehouses, retail stores) for additional improved efficiency.

In other examples, a notification service is provided for DC to DC (D2D) error tickets, such as freight shipped from an import building to a regional DC to be shipped to stores. The system provides an email-based notification service used to send alerts when a ticket was submitted for a D2D load rather than a vendor load. The system adds more detail and an email for tickets that are closed or rejected since there are no vendors or carriers to contact.

A pre-sweep workflow is provided in other examples which is a separate workflow from the primary daily sweep workflow. The pre-sweep workflow performs pre-processing to clean ticket data to prepare them for processing in the daily sweep. This is mostly related to a section in the data where extensible markup language (XML) code is dumped by the error handling component. The data is parsed into individual fields prior to processing.

In some examples, a field in a data table is provided indicating if the ticket has been through the pre-sweep process. If a ticket has not made it through the pre-sweep process, it doesn't go through the daily sweep. In this manner, the system prevents data from going through the primary workflow prior to pre-processing in the pre-sweep.

A runner is provided in other examples to schedule two flows in sequence. The workflow runner or scheduler component (process sequencer) runs the daily sweep only after the pre sweep is finished. An error checking process can also be performed. If the pre-sweep workflow fails for some reason, the error checking triggers the pre-sweep to run again before running the daily sweep. This provides better speed and consistency in the workflow running successfully.

In other notification, if an error ticket is denied or closed, the system updates the ticket or data table for the ticket with a reason for the closure or denial. For example, if error ticket data is invalidated, the ticket is closed or denied and the records are updated to include the invalid data reason.

Other examples provide user roles in the business super user side of the rules engine. These roles allow users to designate themselves as D2D or non-D2D. A user that only deals with vendors does not have to filter through D2D tickets as they are hidden from them based on their role.

Still other examples provide data source mapping for D2D dashboard data publishing to allow data to be sent from VCOE to D2D. The system can be used to submit feedback to the D2D system. The D2D system can also accept other input from VCOE system. For example, the VCOE system can upload images (photos) of received items into the D2D application and dashboard. This enables DCs to review any D2D received freight errors that have been submitted to them. In one example, pictures of received items are posted in an online location within the VCOE system. A link to the pictures is sent into the D2D application to be displayed on the dashboard for inclusion with details of a particular D2D error ticket.

Other examples provide a cloud-based system for handling tickets that identifies errors in received freight. The system includes a front-end application that collects data about errors in received freight. The system sends data to a rules engine for processing. The rules engine applies user-configurable rules to determine when additional information is needed from a user, whether photos are required, how many photos are required, when to notify providers, appropriate remedies to resolve error tickets, when to follow-up regarding unresponsive providers, when to notify human users to follow-up, when to request additional information from other data sources, and when to close or deny an error ticket.

Alternatively, or in addition to the other examples described herein, examples include any combination of the following:
creating error tickets at a point of origin at which the non-compliant item is received;
a user-configurable rules engine;
determining whether to automatically process an error ticket or manually process the error ticket;
using a single string field to pass data from an application front-end to a back-end cloud server;
a pre-sweep process to parse data in a single string field and fill in appropriate fields in a table;
an application front-end that collects data associated with non-damage related errors in received freight from users and sends the data to the rules-engine for processing;
a cloud-based rules engine that applies user-configurable set of rules to automatically determine whether to request additional information from the user regarding the ticket, notify vendors regarding possible remedies, notify DC personnel regarding errors, or close the ticket;
provide a workflow engine for processing, enhancing, and adding to data collected from users regarding errors in received freight;
determine when a photograph is needed for ticket processing;
determine how many photos are required;
send alerts to users when appropriate;
request additional information when needed;
a notification component, implemented on the at least one processor, sends an alert notification identifying the non-damage related error, the received item ID, and a proposed remedy to the provider;
wherein the provider comprises at least one of a vendor, a carrier, or a provider DC;
a pre-sweep component, implemented on the at least one processor, parses data extracted from the error ticket prior to processing of the extracted data by a daily sweep component, wherein the pre-sweep component sets a flag in a data table associated with the parsed data to indicate pre-sweep processing is complete;
a dashboard user interface configured to display aggregated error data in a set of one or more reports, the aggregated error data including an error data from a plurality of error tickets.
a set of cameras associated with the point of origin, wherein the set of cameras generates the set of images of the received item automatically via a set of one or more cameras associated with the point of origin and uploads the set of images to a user device associated with the Error handling component;
a second set of user-configurable rules, wherein the error resolution component identifies a set of recommended remedies for the detected non-damage related error based on application of the second set of user-configurable rules to the error data, wherein the second set of user-configurable rules specify at least one acceptable remedy to resolve the error ticket;
a set of data sources storing received freight data, wherein a VCOE component obtains additional information associated with the received item from at least one data source in the set of data sources;
a notification component, implemented on the at least one processor, transmits a notification alert associated with the detected non-damage related error from a first DC to a second DC, wherein the notification alert comprises a link to the set of images associated with the error ticket;
creating, by an error handling component, an error ticket associated with a detected non-damage related error in at least one received item at a point of origin based on a first set of user-configurable rules;
prompting, by a user interface component, a user to enter additional information responsive to a set of user-configurable rules indicating at least one item of additional information is desirable based on a type of the detected non-damage related error;
identifying, by a rules engine, a pre-determined number of images of the received items to be uploaded with the error ticket based on at least one of a type of the received item, the type of the detected non-damage related error and a provider associated with the received item;
capturing, by a set of image capture devices, a set of images of the received item including the pre-determined number of images;
uploading, by a communications interface device, the error ticket to an error resolution component associated with a cloud server via a network, the error ticket including at least one of the additional information and the set of images of the received item;
sending, by a notification component, an alert notification identifying the non-damage related error, the received item rD, and a proposed remedy to the provider, wherein the provider comprises at least one of a vendor, a carrier, or a provider DC;
prompting, via the user interface component, the user to manually capture the set of images of the received item via at least one camera associated with a user device;
generating the set of images of the received item automatically via a set of one or more cameras associated with the point of origin;
analyzing, by a rules engine, error data extracted from the error ticket with a second set of user-configurable rules;
determining, by the error resolution component, a set of recommended remedies for the detected non-damage related error based on application of the second set of user-configurable rules to the error data, wherein the second set of user-configurable rules specify at least one acceptable remedy to resolve the error ticket;
obtaining, from a set of data sources, additional information associated with the received item; and
sending, by a notification component, a notification alert associated with the detected non-damage related error from a first DC to a second DC, wherein the notification alert comprises a link to the set of images associated with the error ticket.

At least a portion of the functionality of the various elements in FIG. 1, FIG. 2, FIG. 3, FIG. 4, FIG. 5, FIG. 6, FIG. 7, FIG. 8, FIG. 9, FIG. 10, and FIG. 11 can be performed by other elements in FIG. 1, FIG. 2, FIG. 3, FIG. 4, FIG. 5, FIG. 6, FIG. 7, FIG. 8, FIG. 9, FIG. 10, and FIG. 11, or an entity (e.g., processor 106, web service, server, application program, computing device, etc.) not shown in FIG. 1, FIG. 2, FIG. 3, FIG. 4, FIG. 5, FIG. 6, FIG. 7, FIG. 8, FIG. 9, FIG. 10, and FIG. 11.

In some examples, the operations illustrated in FIG. 12, FIG. 13, FIG. 14, FIG. 15, FIG. 16, FIG. 17, and FIG. 18 can be implemented as software instructions encoded on a computer-readable medium, in hardware programmed or designed to perform the operations, or both. For example, aspects of the disclosure can be implemented as a system on a chip or other circuitry including a plurality of interconnected, electrically conductive elements.

In other examples, a computer readable medium having instructions recorded thereon which when executed by a computer device cause the computer device to cooperate in performing a method of error ticket handling, the method comprising creating, by an error handling component, an error ticket associated with a detected non-damage related error in at least one received item at a point of origin based on a first set of user-configurable rules; prompting, by a user interface component, a user to enter additional information responsive to a set of user-configurable rules indicating at least one item of additional information is desirable based on a type of the detected non-damage related error; identifying, by a rules engine, a pre-determined number of images of the received items to be uploaded with the error ticket based on at least one of a type of the received item, the type of the detected non-damage related error and a provider associated with the received item; capturing, by a set of image capture devices, a set of images of the received item including the pre-determined number of images; and uploading, by a communications interface device, the error ticket to an error resolution component associated with a cloud server via a network, the error ticket including at least one of the additional information and the set of images of the received item.

While the aspects of the disclosure have been described in terms of various examples with their associated operations, a person skilled in the art would appreciate that a combination of operations from any number of different examples is also within scope of the aspects of the disclosure.

The term “Wi-Fi” as used herein refers, in some examples, to a wireless local area network using high frequency radio signals for the transmission of data. The term “BLUETOOTH®” as used herein refers, in some examples, to a wireless technology standard for exchanging data over short distances using short wavelength radio transmission. The term “NFC” as used herein refers, in some examples, to a short-range high frequency wireless communication technology for the exchange of data over short distances.

### Exemplary Operating Environment

Exemplary computer-readable media include flash memory drives, digital versatile discs (DVDs), compact discs (CDs), floppy disks, and tape cassettes. By way of example and not limitation, computer-readable media comprise computer storage media and communication media. Computer storage media include volatile and nonvolatile, removable, and non-removable media implemented in any method or technology for storage of information such as computer-readable instructions, data structures, program modules and the like. Computer storage media are tangible and mutually exclusive to communication media. Computer storage media are implemented in hardware and exclude carrier waves and propagated signals. Computer storage media for purposes of this disclosure are not signals per se. Exemplary computer storage media include hard disks, flash drives, and other solid-state memory. In contrast, communication media typically embody computer-readable instructions, data structures, program modules, or the like, in a modulated data signal such as a carrier wave or other transport mechanism and include any information delivery media.

Although described in connection with an exemplary computing system environment, examples of the disclosure are capable of implementation with numerous other special purpose computing system environments, configurations, or devices.

Examples of well-known computing systems, environments, and/or configurations that can be suitable for use with aspects of the disclosure include, but are not limited to, mobile computing devices, personal computers, server computers, hand-held or laptop devices, multiprocessor systems, gaming consoles, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, and the like. Such systems or devices can accept input from the user in any way, including from input devices such as a keyboard or pointing device, via gesture input, proximity input (such as by hovering), and/or via voice input.

Examples of the disclosure can be described in the general context of computer-executable instructions, such as program modules, executed by one or more computers or other devices in software, firmware, hardware, or a combination thereof. The computer-executable instructions can be organized into one or more computer-executable components or modules. Generally, program modules include, but are not limited to, routines, programs, objects, components, and data structures that perform tasks or implement abstract data types. Aspects of the disclosure can be implemented with any number and organization of such components or modules. For example, aspects of the disclosure are not limited to the specific computer-executable instructions or the specific components or modules illustrated in the figures and described herein. Other examples of the disclosure can include different computer-executable instructions or components having more functionality or less functionality than illustrated and described herein.

In examples involving a general-purpose computer, aspects of the disclosure transform the general-purpose computer into a special-purpose computing device when configured to execute the instructions described herein.

The examples illustrated and described herein as well as examples not specifically described herein but within the scope of aspects of the disclosure constitute exemplary means for creating and handling error tickets. For example, the elements illustrated in FIG. 1, FIG. 2, FIG. 3, FIG. 4, FIG. 5, FIG. 6, FIG. 7, FIG. 8, FIG. 9, FIG. 10, and FIG. 11, such as when encoded to perform the operations illustrated in FIG. 12, FIG. 13, FIG. 14, FIG. 15, FIG. 16, FIG. 17 and FIG. 18, constitute exemplary means for creating, by an error handling component, an error ticket associated with a detected non-damage related error in at least one received item at a point of origin based on a first set of user-configurable rules; exemplary means for prompting, by a user interface component, a user to enter additional information responsive to a set of user-configurable rules indicating at least one item of additional information is desirable based on a type of the detected non-damage related error; exemplary means for identifying, by a rules engine, a pre-determined number of images of the received items to be uploaded with the error ticket based on at least one of a type of the received item, the type of the detected non-damage related error and a provider associated with the received item; exemplary means for capturing, by a set of image capture devices, a set of images of the received item including the pre-determined number of images; and exemplary means for uploading, by a communications interface device, the error ticket to an error resolution component associated with a cloud server via a network, the error ticket including at least one of the additional information and the set of images of the received item.

Other non-limiting examples provide one or more computer storage devices having a first computer-executable instructions stored thereon for creating and handling error ticket data associated with non-damage related errors in received freight. When executed by a computer, the computer performs operations including creating, by an error handling component, an error ticket associated with a detected non-damage related error in at least one received item at a point of origin based on a first set of user-configurable rules; prompting, by a user interface component, a user to enter additional information responsive to a set of user-configurable rules indicating at least one item of additional information is desirable based on a type of the detected non-damage related error; identifying, by a rules engine, a pre-determined number of images of the received items to be uploaded with the error ticket based on at least one of a type of the received item, the type of the detected non-damage related error and a provider associated with the received item; capturing, by a set of image capture devices, a set of images of the received item including the pre-determined number of images; uploading, by a communications interface device, the error ticket to an error resolution component associated with a cloud server via a network, the error ticket including at least one of the additional information and the set of images of the received item; and displaying, via a dashboard, aggregated error data associated with a plurality of error tickets.

The order of execution or performance of the operations in examples of the disclosure illustrated and described herein is not essential, unless otherwise specified. That is, the operations can be performed in any order, unless otherwise specified, and examples of the disclosure can include additional or fewer operations than those disclosed herein. For example, it is contemplated that executing or performing an operation before, contemporaneously with, or after another operation is within the scope of aspects of the disclosure.

When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there can be additional elements other than the listed elements. The term “exemplary” is intended to mean “an example of” The phrase “one or more of the following: A, B, and C” means “at least one of A and/or at least one of B and/or at least one of C.”

In an exemplary embodiment, one or more of the exemplary embodiments include one or more localized Internet of Things (IoT) devices and controllers. As a result, in an exemplary embodiment, the localized IoT devices and controllers can perform most, if not all, of the computational load and associated monitoring and then later asynchronous uploading of summary data can be performed by a designated one of the IoT devices to a remote server. In this manner, the computational effort of the overall system can be reduced significantly. For example, whenever localized monitoring allows remote transmission, secondary utilization of controllers keeps securing data for other IoT devices and permits periodic asynchronous uploading of the summary data to the remote server. In addition, in an exemplary embodiment, the periodic asynchronous uploading of summary data can include a key kernel index summary of the data as created under nominal conditions. In an exemplary embodiment, the kernel encodes relatively recently acquired intermittent data (“KRI”). As a result, in an exemplary embodiment, KRI includes a continuously utilized near term source of data, but KRI can be discarded depending upon the degree to which such KRI has any value based on local processing and evaluation of such KRI. In an exemplary embodiment, KRI may not even be utilized in any form if it is determined that KRI is transient and can be considered as signal noise. Furthermore, in an exemplary embodiment, the kernel rejects generic data to provide a modified kernel (“KRG”) by filtering incoming raw data using a stochastic filter that thereby provides a predictive model of one or more future states of the system and can thereby filter out data that is not consistent with the modeled future states which can, for example, reflect generic background data. In an exemplary embodiment, KRG incrementally sequences all future undefined cached kernels of data to filter out data that can reflect generic background data. In an exemplary embodiment, KRG further incrementally sequences all future undefined cached kernels having encoded asynchronous data to filter out data that can reflect generic background data.

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A system for handling errors in received freight, the system comprising:
at least one processor communicatively coupled to a memory;
an error handling application, implemented on the at least one processor, creates an error ticket associated with a detected non-damage related error in at least one received item based on a set of user-configurable rules;
a user interface component, prompts a user to enter additional information responsive to an indication that at least one item of additional information is desirable based on a type of the detected non-damage related error;
a rules engine, identifies a pre-determined number of images of the received items to be uploaded with the error ticket based on at least one of a type of the received item, the type of the detected non-damage related error and a provider associated with the received item;
an image capture device, captures a set of images of the received item including the pre-determined number of images; and
a communications interface component, implemented on the at least one processor, uploads the error ticket to an error resolution component associated with a cloud server via a network, the error ticket including at least one of the additional information and the set of images of the received item.

2. The system of claim 1, further comprising:
a notification component, implemented on the at least one processor, sends an alert notification identifying at least one non-damage related error, a received item ID, and a proposed remedy to the provider, wherein the provider comprises at least one of a vendor, a carrier, or a provider DC.

3. The system of claim 1, further comprising:
a pre-sweep component, implemented on the at least one processor, parses data extracted from the error ticket prior to processing of extracted data by a daily sweep component, wherein the pre-sweep component sets a flag in a data table associated with the parsed data to indicate pre-sweep processing is complete.

4. The system of claim 1, further comprising:
a dashboard user interface configured to display aggregated error data in a set of one or more reports, aggregated error data including error data from a plurality of error tickets.

5. The system of claim 1, wherein the set of user-configurable rules is a first set of user-configurable rules and further comprising:
a second set of user-configurable rules, wherein the error resolution component identifies a set of recommended remedies for the detected non-damage related error based on application of the second set of user-configurable rules to error data, wherein the second set of user-configurable rules specify at least one acceptable remedy to resolve the error ticket.

6. The system of claim 1, further comprising:
a set of data sources storing received freight data, wherein a VCOE component obtains additional information associated with the received item from at least one data source in the set of data sources.

7. The system of claim 1, further comprising:
a notification component, implemented on the at least one processor, transmits a notification alert associated with the detected non-damage related error from a first DC to a second DC, wherein the notification alert comprises a link to the set of images associated with the error ticket.

8. A computer-implemented method for handling errors in received freight, the computer-implemented method comprising:
creating, by an error handling component, an error ticket associated with a detected non-damage related error in at least one received item based on a set of user-configurable rules;
prompting, by a user interface component, a user to enter additional information responsive to the set of user-configurable rules indicating at least one item of additional information is desirable based on a type of the detected non-damage related error;
identifying, by a rules engine, a pre-determined number of images of the received items to be uploaded with the error ticket based on at least one of a type of the received item, the type of the detected non-damage related error and a provider associated with the received item;
capturing, by an image capture device, a set of images of the received item including the pre-determined number of images; and
uploading, by a communications interface device, the error ticket to an error resolution component associated with a cloud server via a network, the error ticket including at least one of the additional information and the set of images of the received item.

9. The computer-implemented method of claim 8, further comprising:
displaying, via a dashboard user interface, aggregated error data associated with a plurality of error tickets.

10. The computer-implemented method of claim 8, further comprising:
prompting, via the user interface component, the user to manually capture the set of images of the received item via at least one camera associated with a user device.

11. The computer-implemented method of claim 8, further comprising:
generating the set of images of the received item automatically via a set of one or more cameras associated with a point of origin.

12. The computer-implemented method of claim 8, wherein the set of user-configurable rules is a first set of user-configurable rules, and further comprising:
analyzing, by a rules engine, error data extracted from the error ticket with a second set of user-configurable rules; and
determining, by the error resolution component, a set of recommended remedies for the detected non-damage related error based on application of the second set of user-configurable rules to the error data, wherein the second set of user-configurable rules specify at least one acceptable remedy to resolve the error ticket.

13. The computer-implemented method of claim 8, further comprising:
obtaining, from a set of data sources, additional information associated with the received item.

14. The computer-implemented method of claim 8, further comprising:
sending, by a notification component, a notification alert associated with the detected non-damage related error from a first DC to a second DC, wherein the notification alert comprises a link to the set of images associated with the error ticket.

15. One or more computer storage devices, having computer-executable instructions for handling errors in received freight by an error handling component that, when executed by a computer cause the computer to perform operations comprising:
creating, by an error handling component, an error ticket associated with a detected non-damage related error in at least one received item based on a set of user-configurable rules;
prompting, by a user interface component, a user to enter additional information responsive to an indication at least one item of additional information is desirable based on a type of the detected non-damage related error;
identifying, by a rules engine, a pre-determined number of images of the received items to be uploaded with the error ticket based on at least one of a type of the received item, the type of the detected non-damage related error and a provider associated with the received item;
capturing, by an image capture device, a set of images of the received item including the pre-determined number of images;
uploading, by a communications interface device, the error ticket to an error resolution component associated with a cloud server via a network, the error ticket including at least one of the additional information and the set of images of the received item; and
displaying, via a dashboard, aggregated error data associated with a plurality of error tickets.

16. The one or more computer storage devices of claim 15, wherein a notification component, when further executed by a computer, causes the computer to perform operations comprising:
sending an alert notification identifying at least one non-damage related error, a received item ID, and a proposed remedy to the provider, wherein the provider comprises at least one of a vendor, a carrier, or a provider DC.

17. The one or more computer storage devices of claim 15, wherein a notification component, when further executed by a computer, causes the computer to perform operations comprising:
sending a notification alert associated with the detected non-damage related error from a first DC to a second DC, wherein the notification alert comprises a link to the set of images associated with the error ticket.

18. The one or more computer storage devices of claim 15, wherein a notification component, when further executed by a computer, causes the computer to perform operations comprising:
prompting, via the user interface component, the user to manually capture the set of images of the received item via at least one camera associated with a user device.

19. The one or more computer storage devices of claim 15, wherein a notification component, when further executed by a computer, causes the computer to perform operations comprising:
generating the set of images of the received item automatically via a set of one or more cameras associated with a point of origin.

20. The one or more computer storage devices of claim 15, wherein an error resolution component, when further executed by a computer, causes the computer to perform operations comprising:
determining a set of recommended remedies for the detected non-damage related error based on application of the set of user-configurable rules to error data, wherein the set of user-configurable rules specify at least one acceptable remedy to resolve the error ticket.
